(19) United States
(12) Patent Application Publication
(10) Pub. No.: US 2007/0253311 A1
(43) Pub. Date: Nov. 1, 2007

(54) OPTICAL PICK-UP APPARATUS AND OPTICAL DISC APPARATUS

(75) Inventors: Shogo HORINOUCHI, FUKUOKA (JP); Taiichi MORI, FUKUOKA (JP); Takashi HARUGUCHI, FUKUOKA (JP); Hideki YOSHINAKA, FUKUOKA (JP); Toshihiro KOGA, KUMAMOTO (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/737,398

(22) Filed: Apr. 19, 2007

(30) Foreign Application Priority Data
Apr. 21, 2006 (JP) 2006-117606

(51) Int. Cl. G11B 7/00

(52) U.S. Cl. 369/112.22; 369/112.16; 369/112.01

(57) ABSTRACT

To provide an optical pick-up apparatus and an optical disc apparatus preventing a polarization hologram from being deteriorated by incidence of laser light having a wavelength for a blue laser into the polarization hologram for a CD or a DVD, an optical pick-up apparatus includes a first objective lens 10 converging first laser light having a long wavelength and irradiating it onto a first optical disc, a second objective lens 13 disposed adjacent to the first objective lens 10, which converges second laser light having a shorter wavelength than the first laser light and irradiates it onto a second optical disc, a standing mirror 9 allowing the first laser light to be irradiated onto the first objective lens 10 and transmitting the second laser light, and a filter film 11g provided between the first objective lens 10 and the standing mirror 9, which transmits the laser light and screens the second laser light.

### BACKGROUND OF THE INVENTION

1. Field of the Invention

The present invention relates to an optical pick-up apparatus and an optical disc apparatus used for performing a recording operation and a reproducing operation on both an optical disc such as a CD or a DVD and an optical disc for a blue laser.

2. Description of the Related Art

In an optical pick-up performing a recording operation and a reproducing operation on an optical disc, a laser diode emitting a long wavelength laser such as an infrared laser or a red laser was used in the related art, but an optical disc apparatus performing a high density recording operation by using a blue laser has been practically used in recent years.

However, in a phase when an optical disc for the blue laser and the known CD or DVD coexist, it is proposed that a recording operation and a reproducing operation on plural kinds of optical discs having different wavelengths may be performed by the same optical disc apparatus.

Since the long wavelength laser and the blue laser are different in diameter of a spot converging on a recording surface of the optical disc and in refractive index of an optical member such as an objective lens depending on the wavelength, they cannot commonly use the same optical system. Therefore, when the different optical systems for each wavelength are provided, there is no problem in performing the recording operation and the reproducing operation on the plural kinds of optical discs.

However, there is a difficult requirement that an optical disc apparatus mounted on an electronic apparatus such as a notebook PC of which a decrease in thickness and a decrease in size are required includes a recording and reproducing mechanism of the disc corresponding to the blue laser additionally housed in a space occupied by the known optical disc for the long wavelength laser. Accordingly, it is difficult to provide the optical system for performing the recording and reproducing operations on the disc corresponding to the blue laser in a very small space independently of the known mechanism. Therefore, it is proposed to save a space by commonly using a part of the optical system.

For example, in (Patent Document 1), the optical pick-up apparatus is disclosed which includes a plurality of light sources emitting a plurality of light beams having a plurality of different wavelengths, wherein the light beams, at least a part thereof which are emitted from the plurality of light sources passes through the same light path and units converging onto different optical discs are independently provided depending on the wavelengths.

FIG. 8 is a schematic view illustrating a basic configuration of the optical system of the optical pick-up apparatus disclosed in (Patent Document 1). In the figure, reference numeral 101 represents a first light source (the laser diode) emitting two-wavelength (infrared to red) laser light for performing a recording operation and a reproducing operation on a CD or a DVD, reference numeral 102 represents an optical member transmitting outward light and reflecting inward light on a reflective surface, reference numeral 103 represents a second light source (a blue laser diode) emitting laser light of a short wavelength (400 nm to 415 nm) for performing the recording operation and the reproducing operation of the disc corresponding to the blue laser, reference numeral 104 represents an optical member transmitting the outward light and reflecting the inward light on the reflective surface, reference numeral 105 represents a beam splitter serving as an optical part having a reflective surface transmitting long wavelength laser light and reflecting short wavelength laser light, reference numeral 106 represents an optical member (a standing mirror) transmitting the long wavelength laser light and reflecting the short wavelength laser light, reference numeral 107 represents an optical member having an opening filter for acquiring the number of openings required to correspond to the optical disc such as the DVD (light of approximately 660 nm wavelength) or the CD (light of approximately 780 nm wavelength), a polarization hologram reacting on light of approximately 660 nm wavelength, and a ¼ wavelength plate, reference numeral 108 represents an objective lens, reference numeral 109 represents an optical disc, reference numeral 110 represents an optical member (the standing mirror) reflecting the short wavelength laser light, reference numeral 111 represents an achromatic diffractive lens compensating chromatic aberration, reference numeral 112 represents an objective lens, reference numeral 113 represents a light detector receiving inward light of a long wavelength reflected by the optical member 102, and reference numeral 114 represents a light detector receiving inward light of a short wavelength reflected by the optical member 104.

Basically, by this configuration, it becomes possible to perform the recording operation and the reproducing operation on the CD or the DVD corresponding to the long wavelength laser and the optical disc corresponding to the short wavelength laser (the blue laser).

An optical pick-up apparatus using a two-wavelength laser unit for the CD or the DVD is disclosed in, for example, (Patent Document 2).

Patent Document 1: Japanese Unexamined Patent Application Publication No. 2005-85293

Patent Document 2: Japanese Unexamined Patent Application Publication No. 2001-307367

However, a blue laser emitted from a second light source 103 is transmitted onto an optical member 104, is reflected on a reflective surface of a beam splitter 105, and is transmitted onto an optical member 106. At this time, the blue laser is ideally transmitted onto the optical member 106, but the blue laser of several % is reflected on the reflective surface of the optical member 106 and is incident into an optical member 107 in actuality. As described above, the optical member 107 includes optical members such as an opening filter, a polarization hologram, and an optical member such as a ¼ wavelength plate laminated thereon and is made of synthetic resin.

The blue laser has a shorter wavelength and larger energy than an infrared laser or a red laser. Accordingly, when even slight light is continuously irradiated or accumulated irradiation time is increased, the synthetic resin constituting the optical member 107 is slowly deteriorated for a long time, thereby decreasing a transmittance of long wavelength laser light. In particular, the polarization hologram transmits most of outward light and changes a polarization state so that inward light reaches a light detector 113 through a beam splitter 105 and an optical member 102, and is formed of an organic thin film polarization material. The blue laser is continuously irradiated onto the organic thin film polarization material and the accumulated irradiation time is increased. Accordingly, the organic thin film polarization material is slowly deteriorated, thereby decreasing a diffractive efficiency serving as one of performances of the polarization hologram.

### SUMMARY OF THE INVENTION

Therefore, an object of the invention is to prevent the polarization hologram from being deteriorated by incidence of the laser light having a wavelength of a blue laser onto the polarization hologram for a CD or a DVD, and maintaining performance of the optical pick-up apparatus and acquiring an increase in life of an optical pick-up apparatus in an optical pick-up apparatus commonly using a part of an optical system with a light source having a wavelength for the CD or the DVD and a light source having a wavelength for the blue laser.

In an optical pick-up apparatus according to an aspect of the invention, a filter transmitting laser light having a predetermined long wavelength and screening laser light having a wavelength for a disc corresponding to a blue laser is provided in front of polarization hologram diffracting laser light having a wavelength for a CD or a DVD by polarization

In an optical pick-up apparatus according to the invention, a filter transmitting laser light having a predetermined long wavelength and screening laser light having a wavelength for a disc corresponding to a blue laser is provided in front of polarization hologram diffracting laser light having a wavelength for a CD or a DVD by polarization, thereby preventing the polarization hologram from being deteriorated by incidence of the laser light having the wavelength for the blue laser onto the polarization hologram for the CD or the DVD, and maintaining performance of the optical pick-up apparatus and acquiring an increase in life of the optical pick-up apparatus.

### BRIEF DESCRIPTION OF THE DRAWINGS

FIG. 1 is an external perspective view of an optical disc apparatus according to an embodiment of the invention.

FIG. 2 is a schematic view illustrating an optical pick-up apparatus according to an embodiment of the invention.

FIG. 3 is a plan view illustrating a configuration of an optical pick-up apparatus according to an embodiment of the invention.

FIG. 4 is an enlarged view of a primary part of an optical system adjacent to an optical disc including an optical member according to an embodiment of the invention.

FIG. 5(a) is a schematic view illustrating a configuration of the known optical member having an only antireflective film and FIG. 5(b) is a schematic view illustrating a configuration of the optical member having a filter film according to an embodiment of the invention.

FIG. 6(a) is a diagram illustrating wavelength characteristics such as a reflectance and a transmittance of the optical member having an only antireflective film and FIG. 6(b) is a diagram illustrating wavelength characteristics such as a reflectance and a transmittance of an optical member having a filter film according to an embodiment of the invention.

FIG. 7 is a graph illustrating a relation between a blue-purple light transmittance of a filter film having an antireflective film and a reduction rate of a diffraction efficiency of a polarization hologram.

FIG. 8 is a schematic view illustrating a basic configuration of an optical system of an optical pick-up apparatus disclosed in (Patent Document 1).

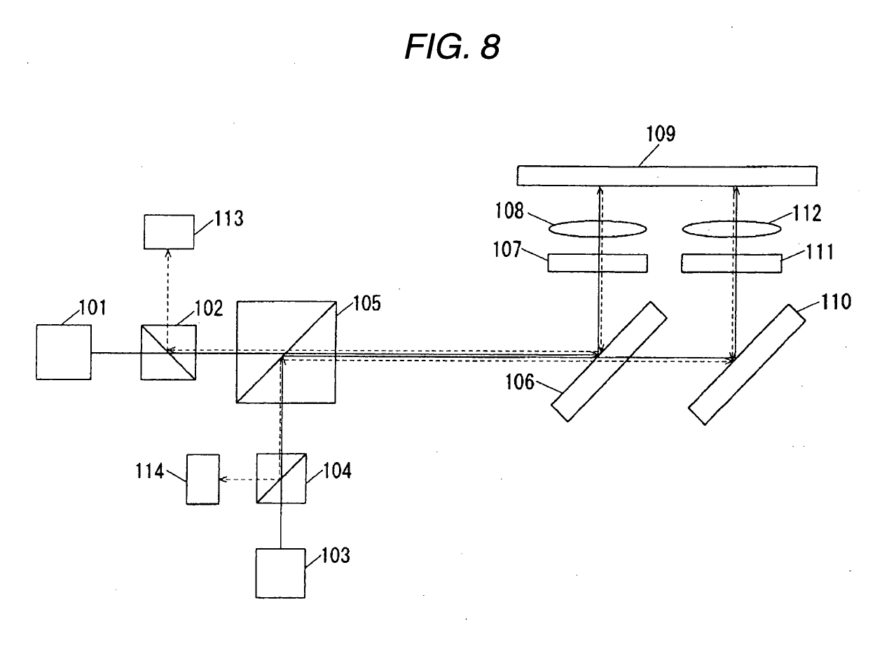

### DESCRIPTION OF THE PREFERRED EMBODIMENTS

According to an embodiment of the invention, in an optical pick-up apparatus commonly using a part of an optical system with a light source having a wavelength for a CD or a DVD and a light source having a wavelength for a blue laser, an object to prevent the polarization hologram from being deteriorated by incidence of the laser light having a wavelength of a blue laser onto the polarization hologram for the CD or the DVD, and maintain performance of the optical pick-up apparatus and acquire an increase in life of the optical pick-up apparatus.

According to an embodiment of the invention contrived to solve the problem, the optical pick-up apparatus includes a first objective lens converging first laser light having a long wavelength and irradiating it onto a first optical disc, a second objective lens disposed adjacent to the first objective lens, which converges second laser light having a shorter wavelength than the first laser light and irradiates it onto a second optical disc, an optical member allowing the first laser light to be irradiated onto the first objective lens and transmitting the second laser light, and a filter provided between the first objective lens and the optical member, which transmits the laser light and screens the second laser light.

### Embodiments

Hereinafter, embodiments of the invention will be described with reference to the accompanying drawings.

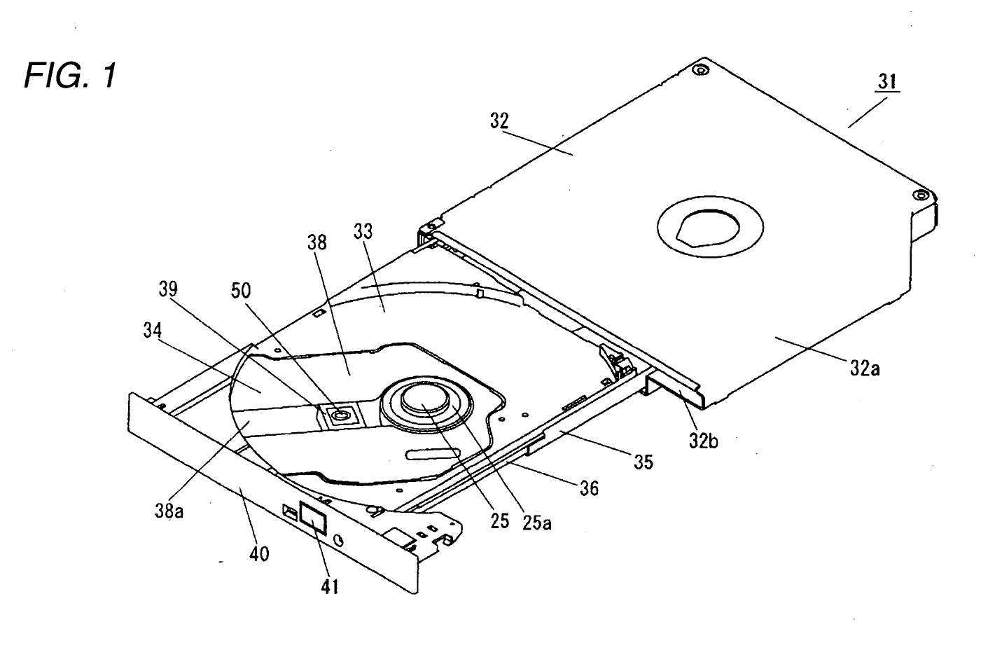

FIG. 1 is an external perspective view of an optical disc apparatus according to an embodiment of the invention and illustrates a state in which a tray on which an optical disc is placed is drawn out from a case.

In FIG. 1, reference numeral 31 represents an optical disc apparatus, reference numeral 32 represents the case, reference numeral 32a represents an upper case portion, reference numeral 32b represents a lower case portion, reference numeral 33 is the tray, reference numeral 34 represents an optical pick-up module, reference numeral 35 represents a rail, reference numeral 36 is a rail guide part, reference numeral 25 represents a spindle motor, reference numeral 25a represents an optical disc mounting portion, reference numeral 38 represents a cover, reference numeral 38a represents an opening, reference numeral 39 represents a carriage, reference numeral 40 represents a bezel, reference numeral 41 represents an eject button, and reference numeral 50 represents an optical pick-up.

An optical disc apparatus 31 has a case 32 and a tray 33 movably held on the case 32. The case 32 is pouched in combination of an upper case portion 32a and a lower case portion 32b made of metal. The tray 33 is drawn out from the opening of the case 32 or is housed in the opening of the case 32. An optical pick-up module 34 is mounted on the tray 33 from a rear surface thereof.

A rail guide part 36 is provided in a side portion of the tray 33 and a rail 35 moves along an external surface of the rail guide part 36. By this configuration, the tray 33 can be drawn out from the case 32 or the tray 33 can be housed in the case 32.

The optical pick-up module 34 at least includes a spindle motor 25 rotating the optical disc, a cover 38 having an opening 38a through an outer periphery from the spindle motor 25, and a carriage 39 of which part is exposed from the opening 38a. The carriage 39 is movably held on a plurality of guide shafts provided in the optical pick-up module 34 and can move close to or move off from the spindle motor 25 with a feed motor not shown.

A bezel 40 is provided in front of the tray 33 and has a size enough to plug the opening of the case 32. A light source such as a high-power laser diode, various optical members, and an object lens constituting a light spot on the optical disc are mounted on the carriage 39. A circuit substrate is fixedly provided in an inner portion of the case 32 and a signal processing system IC or a power supply circuit is mounted on the circuit substrate. A flexible print substrate on which circuit substrates not shown provided on the tray 33 are electrically connected to each other is substantially U-shaped and an external connector is connected to a power supply line and a signal line provided in an electronic apparatus such as a computer. Electricity is supplied into the optical disc apparatus 31 through the external connector, a signal received from an external apparatus is guided into the optical disc apparatus 31, or an electrical signal generated in the optical disc apparatus 31 is transmitted to the electronic apparatus. An eject button 41 is provided in the bezel 40 provided on a front end surface of the tray 33 and engagement of an engagement part provided in the case 32 and the an engagement part provided in the case 33 is released by pressing the eject button 41, whereby the tray 33 can be drawn out from the case 32 so that the optical disc can be attached and removed.

Engagement of the engagement part provided in the case 32 and the engagement part provided in the case 33 is released by pressing the eject button 41 and the tray 33 is drawn out from the case 32 so as to draw out the tray 33 when the tray 33 is housed in the case 32. When the tray 33 is drawn out by a predetermined distance, a protrusion provided in the rail guide part 36 and a protrusion provided in the rail 35 contact each other and the protrusion provided in the rail 35 and a protrusion provided in the case 32 contact each other, whereby the tray 33 stops while the tray 33 is drawn out.

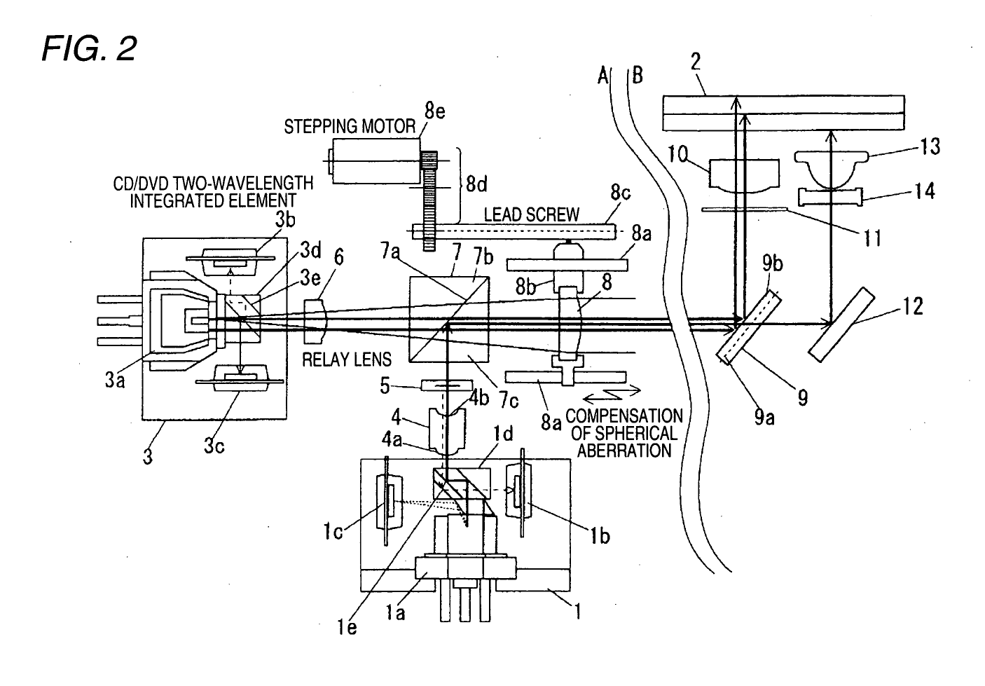

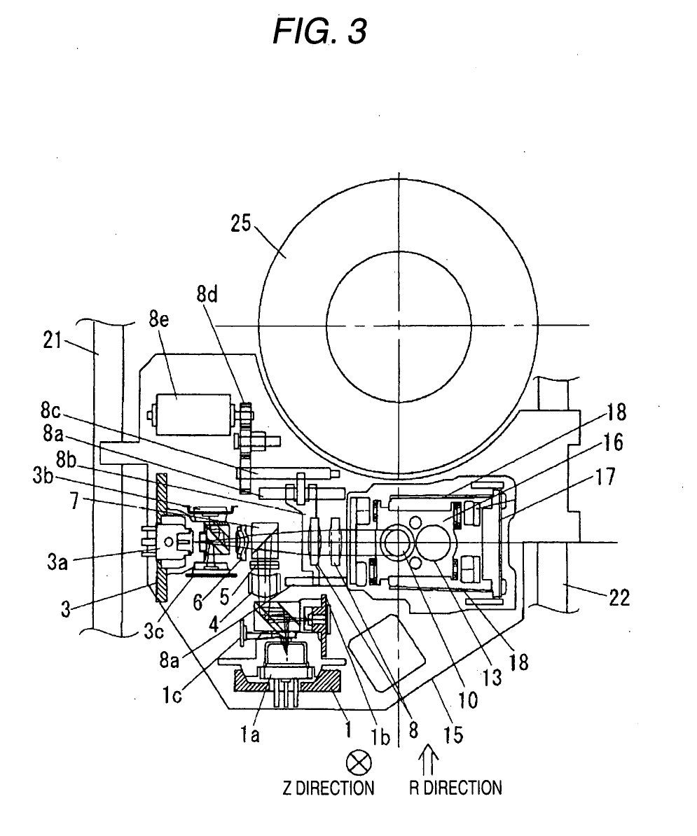

FIG. 2 is a schematic view illustrating a configuration of the optical pick-up apparatus according the embodiment of the invention and FIG. 3 is a plan view illustrating a configuration of the optical pick-up apparatus according to the embodiment of the invention. A side A of double wave lines shown in FIG. 2 is a schematic view illustrating a short wavelength optical unit 1 and a long wavelength optical unit 3 to a collimator lens 8 as viewed in a Z direction (an upper side of paper) shown in FIG. 3 and a side B of the double wave lines shown in FIG. 2 is a schematic view illustrating a standing mirror 9 to the optical disc 2 of the optical pick-up apparatus as viewed in an R direction shown in FIG. 3.

In FIG. 2, reference numeral 1 represents a short wavelength optical unit emitting a short wavelength laser and light emitted from a short wavelength optical unit 1 has a wavelength in the range of 400 nm to 415 nm and light having a wavelength of approximately 405 nm is emitted in the embodiment. In general, light of the above-mentioned laser wavelength shows blue to purple colors. In the embodiment, the short wavelength optical unit 1 is specifically described later, but the short wavelength optical unit 1 includes a light source part 1a emitting the short wavelength laser, a light receiving part 1b for signal detection receiving light reflected from the optical disc 2, a light receiving part 1c monitoring an amount of light emitted from the light source part 1a, an optical member 1d, and a holding member (not shown) holding the constituent members at a predetermined position. The light source part 1a includes a semiconductor laser element (not shown) composed of GaN or primarily composed of GaN. Light emitted the semiconductor laser element is incident into the optical member 1d and a part of the incident light is reflected on the optical member 1d and enters the light receiving part 1c. Although not shown, a circuit is provided which adjusts an intensity of the light emitted from the light source part 1a to a desired intensity on the basis of an electrical signal into which the light receiving part 1c converts. Most of the light emitted from the light source part 1a is guided to the optical disc 2 through the optical member 1d. Light reflected from the optical disc 2 is incident into the light receiving part 1b through the optical member 1d. The light receiving part 1b converts the light into the electrical light and generates an RF signal, a tracking error signal, and a focus error signal from the electrical signal. The optical member 1d includes a polarization hologram 1e separating the light reflected from the optical disc 2 so as to acquire the focus error signal.

In the embodiment, one short wavelength optical unit including the light source part 1a, the light receiving parts 1b and 1c, and the optical member 1d constitutes the optical pick-up apparatus so as to acquire a decrease in size of the optical pick-up apparatus, but at least one of the light receiving parts 1b and 1c may be provided separately from the short wavelength optical unit 1 or the optical member 1d may be provided separately from the short wavelength optical unit 1.

Reference numeral 3 represents a long wavelength optical unit emitting a long wavelength laser. A light beam emitted from the long wavelength optical unit 3 is a wavelength in the range of 640 nm to 800 nm and a light beam having one kind of wavelength is singly emitted or plural light beam having plural kinds of wavelengths are plurally emitted. In the embodiment, a light flux (red light: for example, corresponding to the DVD) of approximately 660 nm and a light flux (infrared light: for example, corresponding to a CD) of approximately 780 nm are emitted. In the embodiment, the long wavelength optical unit 3 is specifically described later, but the long wavelength optical unit 3 includes a light source part 3a emitting the long wavelength laser, a light receiving part 3b for signal detection receiving the light reflected from the optical disc 2, a light receiving part 3c monitoring an amount of light emitted from the light source part 3a, an optical member 3d, and a holding member (not shown) holding the constituent members at a predetermined position. A semiconductor laser element (not shown) is provided in the light source part 3a and the semiconductor laser element includes monoblocks (a monolithic structure). The (red) light flux of approximately 660 nm and the (infrared) light flux of approximately 780 nm are emitted from a monoblock element. In the embodiment, the monoblock element emits two light fluxes, but each of two block element of the semiconductor laser element may emit one light flux. Plural light fluxes emitted from the semiconductor laser element is incident into the optical member 3d and a part of the incident light is reflected on the optical member 3d and enters the light receiving part 3c. Although not shown, a circuit is provided which adjusts an intensity of the light emitted from the light source part 3a to a desired intensity on the basis of an electrical signal into which the light receiving part 3c converts. Most of the light emitted from the light source part 3a is guided to the optical disc 2 through the optical member 3d. Light reflected from the optical disc 2 is incident into the light receiving part 3b through the optical member 3d. The light receiving part 3b converts the light into the electrical signal and generates an RF signal, a tracking error signal, and a focus error signal from the electrical signal. The optical member 3d includes a polarization hologram 3e separating the light beam reflected from the optical disc 2 into plural light beam and guiding the separated plural light beams to predetermined locations of the light receiving part 3b so as to generate a focus error signal for the CD.

In the embodiment, one long wavelength optical unit 3 including the light source part 3a, the light receiving parts 3b and 3c, and the optical member 3d constitutes the optical pick-up apparatus so as to acquire a decrease in size of the optical pick-up apparatus, but at least one of the light receiving parts 3b and 3c may be provided separately from the long wavelength optical unit 3 or the optical member 3d may be provided separately from the long wavelength optical unit 3.

Reference numeral 4 represents a beam shaping lens which the light emitted from the short wavelength optical unit 1 and the light reflected from the optical disc 2 pass through. It is preferable that a beam shaping lens 4 is made of glass having low deterioration caused by passage of the short wavelength laser. In the embodiment, the beam shaping lens 4 is made of glass, but the beam shaping lens 4 may be made of all materials which have low deterioration caused by passage of the short wavelength laser. The beam shaping lens 4 is provided so as to remove astigmatism of the shot wavelength laser and astigmatism caused on a light path reaching the optical disc 2 from the short wavelength optical unit 1. Although the light reflected from the optical disc 2 may be incident into the short wavelength optical unit 1 without passing through the beam shaping lens 4 for the purpose of the beam shaping lens 4, the light reflected from the optical disc 2 is incident into the short wavelength optical unit 1 through the beam shaping lens 4 in terms of an optical arrangement in the embodiment. In the embodiment, although the beam shaping lens 4 is used to reduce astigmatism of the short wavelength light, a beam shaping prism or a beam shaping hologram may be used instead of the beam shaping lens 4.

A convex portion 4a and a concave portion 4b are provided at both end of the beam shaping lens 4. The beam shaping lens 4 is disposed so that the light emitted from the short wavelength optical unit 1 enters the convex portion 4a and is emitted from the concave portion 4b.

Reference numeral 5 represents an optical member. An optical member 5 is disposed in front of the beam shaping lens 4 on the light path and is disposed on the concave portion 4b side of the beam shaping lens 4. In other words, the light emitted from the short wavelength optical unit 1 is incident into the optical member 5 through the beam shaping lens 4 and is guided to the optical disc 2. The light reflected from the optical disc 2 passes through the optical member 5 and the beam shaping lens 4 sequentially, and it is incident into the short wavelength optical unit 1. The polarization hologram is provided in the optical member 5 and at least has the following function. In other words, the polarization hologram has a function of separating the light reflected from the optical disc 2 into predetermined light fluxes so as to primarily generate the tracking error signal. As described above, the polarization hologram 1e provided in the optical member 1d separates the light reflected from the optical disc 2 into plural light fluxes so as to generate the focus error signal and the optical member 5 separates the light into the plural light fluxes so as to generate the tracking error signal.

More specifically, the optical member 5 may serve as an RIM intensity compensating filter attenuating an intensity of light in approximately a middle portion of the short wavelength light. Further, the optical member 5 is divided into two. One side of the optical member 5 may separate the light reflected from the optical disc 2 into the predetermined light fluxes so as to primarily generate the tracking error signal and the other side thereof may serve as the RIM intensity compensating filter.

Reference numeral 6 represents a relay lens which the long wavelength light emitted from the long wavelength optical unit 3 passes through. A relay lens 6 includes a transparent member such as resin or glass. The relay lens 6 efficiently guides the light emitted from the long wavelength optical unit 3 to a rear member. Since the long wavelength optical unit 3 can be disposed closer to a beam splitter 7 side by the relay lens 6, it is possible to acquire a decrease in size of the optical pick-up apparatus.

Reference numeral 7 represents a beam splitter serving as the optical member. At least two transparent members 7b and 7c are provided in contact with each other in a beam splitter 7, one slope face 7a is provided between the transparent members 7b and 7c, and a wavelength selecting film is provided on the slope face 7a. The only wavelength selecting film is directly formed on the slope face 7a of the transparent member 7c which the light emitted from the short wavelength optical unit 1 penetrates and the transparent member 7b contacts the slope face 7a of the transparent member 7c on which the wavelength selecting film is formed with a contact material made of the resin or the glass, which is interposed therebetween.

The beam splitter 7 reflects the short wavelength light emitted from the short wavelength optical unit 1 and transmits the light emitted from the long wavelength optical unit 3. In other words, the light emitted from the short wavelength optical unit 1 and the light emitted from the long wavelength optical unit 3 are guided substantially in the same direction.

Reference numeral 8 represents a collimator lens held to be freely movable. A collimator lens 8 is attached to a slider 8b and the slider 8b is movably attached to a pair of support members 8a provided substantially parallel to each other. A lead screw 8c having a helical groove is provided substantially parallel to the support members 8a and a protrusion inserted into the groove of the lead screw 8c is provided at an end portion of the slider 8b. A gear group 8d is coupled to the lead screw 8c and a driving member 8e is provided in the gear group 8d. A driving force of the driving member 8e is transferred to the lead screw 8c via the gear group 8d and the lead screw 8c rotates by the driving force, whereby the slider 8b moves on the support members 8a. In other words, the collimator lens 8 can move adjacent to or move off from the beam splitter 7 depending on a difference in driving direction or a difference in driving speed of the driving member 8e, and it can adjust the movement speed.

Various motors are pertinently used as the driving member 8e, and more particularly, a stepping motor is preferably used as the driving member 8e. In other words, a rotation number of the lead screw 8c is determined by adjusting the number of pulses transferred to the stepping motor. As the result, a movement distance of the collimator lens 8 can be easily set.

As described above, it is possible to easily adjust a spherical aberration by adopting a configuration in which the collimator lens 8 moves adjacent to or moves off from the beam splitter 7. In other words, since a spherical aberration of the short wavelength light can be adjusted by a position of the collimator lens 3, it is possible to effectively perform at least one of a recording operation and a reproducing operation on a first recording layer provided in the optical disc 2 corresponding to a short wavelength and a second recording layer having a depth different from the first recording layer.

The collimator lens 8 is made of the glass or is preferably made of short wavelength light resistant resin (resin not deteriorated or hard to be deteriorated by the short wave length light) so that the short wavelength light and the long wavelength light incident from the beam splitter 7 are transmitted onto the collimator 8. The collimator lens 8 also transmits the short wavelength light or the long wavelength light reflected from the optical disc 2.

In the embodiment, the collimator lens 8 is moved to the driving member 8e so as to compensate the spherical aberration of the short wavelength light, but the collimator 8 may be moved by other constituent members and the spherical aberration of the short wavelength light may be adjusted using other methods.

Reference numeral 9 represents a standing mirror. A standing mirror 9 includes a ¼ wavelength member 9a acting on the short wavelength light. A ¼ wavelength plate rotating a polarization direction of light passing twice (outward and inward) by approximately 90° is used as the ¼ wavelength member 9a. In the embodiment, the ¼ wavelength member 9a is pinched into the standing mirror 9. A wavelength selecting film 9b is provided on a surface into which the light beams emitted from the units 1 and 3 are incident in the standing mirror 9. The wavelength selecting film 9b reflects most of the long wavelength light emitted from the long wavelength optical unit 3 and transmits most of the short wavelength light emitted from the short wavelength optical unit 1.

Reference numeral 10 represents an objective lens for the long wavelength laser. An objective lens 10 converges the light reflected from the standing mirror 9 into the optical disc 2. In the embodiment, the objective lens 10 is used, but other converging member such as the polarization hologram may be used. Naturally, the light reflected from the optical disc 2 passes through the objective lens 10. The objective lens 10 is made of a material such as the glass or the resin.

Reference numeral 11 represents an optical member provided between the objective lens 10 and the standing mirror 9. An optical member 11 has the opening filter for acquiring the number of openings required to correspond to the optical disc 2 such as the DVD (light of approximately 660 nm wavelength) and the CD (light of approximately 780 nm wavelength), the polarization hologram reacting on the light of approximately 660 nm wavelength, and the ¼ wavelength member (pertinently, the ¼ wavelength plate). The optical member 11 includes a dielectric multilayer film or diffractive grating opening means. The polarization hologram polarizes the light of approximately 660 nm (separating the light of approximately 660 nm wavelength into the light for the tracking error signal or the focus error signal). The ¼ wavelength member rotates the polarization direction of the inward path to the outward path of the light of approximately 660 nm wavelength and the light of approximately 780 nm wavelength by approximately 90°.

Reference numeral 12 represents a standing mirror reflecting most of the short wavelength light. A standing mirror 12 includes a reflective film.

Reference numeral 13 represents an objective lens. An objective lens 13 converges the light reflected from the standing mirror 12 into the optical disc 2. In the embodiment, the objective lens 13 is used, but other converging member such as the polarization hologram may be used. Naturally, the light reflected from the optical disc 2 passes through the objective lens 13. The objective lens 13 is made of the glass or the resin, but the objective lens 13 is preferably made of the short wavelength optical light resistant resin (the resin which is not deteriorated or is resistant to deterioration by the short wavelength light).

Reference numeral 14 represents an achromatic diffractive lens provided between the objective lens 13 and the standing mirror 12. An achromatic diffractive lens 14 compensates chromatism. The achromatic diffractive lens 14 reduces chromatism caused in the optical parts which the short wavelength light passes through. The achromatic diffractive lens 14 basically includes a desired polarization hologram formed on the lens. Compensation degree of chromatism can be determined by adjusting at least one of a lattice pitch of the polarization hologram and a curvature radius of the lens. The achromatic diffractive lens 14 is made of resin such as plastic or cuffs. The achromatic diffractive lens 14 is preferably made of the short wavelength light resistant resin (the resin which is not deteriorated or is resistant to deterioration by the short wavelength light).

Hereinafter, a detailed arrangement of the optical system configured above will be described with reference to FIG. 3.

FIG. 3 illustrates an example of realization of the optical configuration shown in FIG. 2. The members shown in FIG. 3 are a little different from the members shown in FIG. 2 in shape and are much the same as them shown in FIG. 2 in function.

Reference numeral 15 represents a base. The above-mentioned members are fixedly or movably attached to a base 15. The base 15 is made of metal or metal alloy such as zinc, zinc alloy, aluminum, aluminum alloy, titanium, and titanium alloy and it is preferably produced using a die-cast manufacturing method.

The base 15 is movably attached to shafts 21 and 22 disposed approximately parallel to each other and reciprocates by rotation of a screw shaft not shown. A spindle motor 25 rotating the optical disc 2 is provided on the base 5.

The short wavelength optical unit 1, the long wavelength optical unit 3, the beam shaping lens 4, the optical member 5, the relay lens 6, the beam splitter 7, the support member 8a, the lead screw 8c, the gear group 8d, a driving member 8e, and the standing mirrors 9 and 12 are adhered to the base 15 by using organic adhesive such as light cure type adhesive or epoxy adhesive or by using metal adhesive such as soldering or lead-free soldering, or they are attached thereto by methods such as screwing, fitting, and press-fitting.

The lead screw 8c and the gear group 8d are rotatably attached to the base 15.

Reference numeral 17 represents a suspension holder. A suspension holder 17 is attached to the base 15 through a yoke member not shown by using various adherence methods. The lens holder 16 and the suspension holder 17 are coupled through a plurality of suspensions 18. The lens holder 16 is supported on the base 15 so as to be movable by a predetermined range. The objective lenses 10 and 13, the optical member 11, and the achromatic diffractive lens 14 are attached to the lens holder 16. The objective lenses 10 and 13, the optical member 11, and the achromatic diffractive lens 14 move with movement of the lens holder 16.

Since the standing mirror 9 is inclined to a light flux which is emitted from the short wavelength optical unit 1 and passes through the beam splitter 7 or the collimator lens 8, the light flux emitted from the short wavelength optical unit 1 is refracted and moves off from the objective lenses 10 and 13 by a predetermined distance when it passes through the standing mirror 9.

The objective lens 10 and the objective lens 13 having an axial thickness larger than the objective lens 10 are sequentially arranged in a proceeding direction of the light which is emitted from the short wavelength optical unit 1 or the long wavelength optical unit 3 and passes through the beam splitter 7 or the collimator lens 8.

Since the light flux may not be screened by the objective lens 13 or the achromatic diffractive lens 14, even though the lens holder 16 drives up and down by the arrangement of the objective lenses 10 and 13, it is possible to acquire a decrease in thickness of the optical pick-up apparatus.

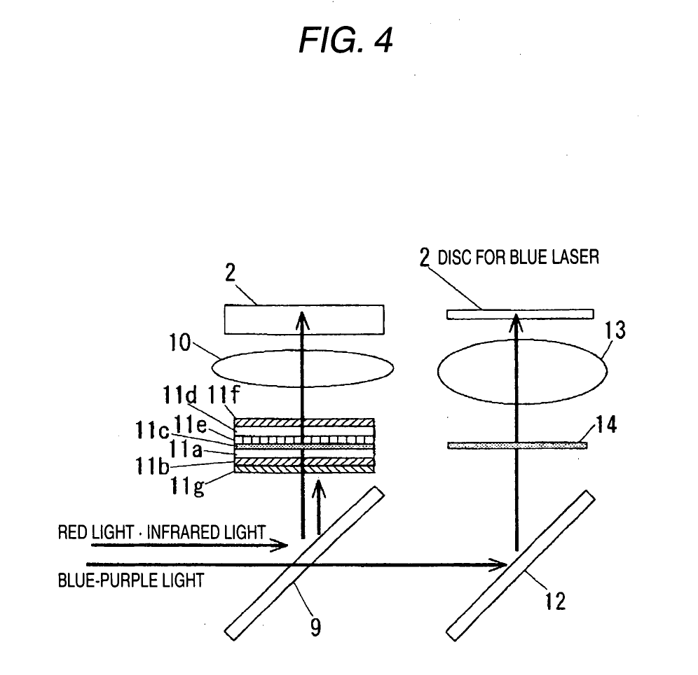

FIG. 4 is an enlarged view of a primary part of the optical system adjacent to the optical disc including the optical member according to the embodiment of the invention. The optical member 11 includes an antireflective film 11b formed on a lower surface of a first glass substrate 11a and the polarization hologram 11c formed on an upper surface thereof, and a ¼ wavelength plate 11e formed a lower surface of a second glass substrate 11d and an antireflective film 11f formed on an upper surface thereof laminated. In the embodiment, a filter film 11g is formed on a surface of the antireflective film 11b. The filter film 11g transmits the laser light of the wavelength for the CD or the DVD and screens the laser light of the wavelength for the disc corresponding to the blue laser.

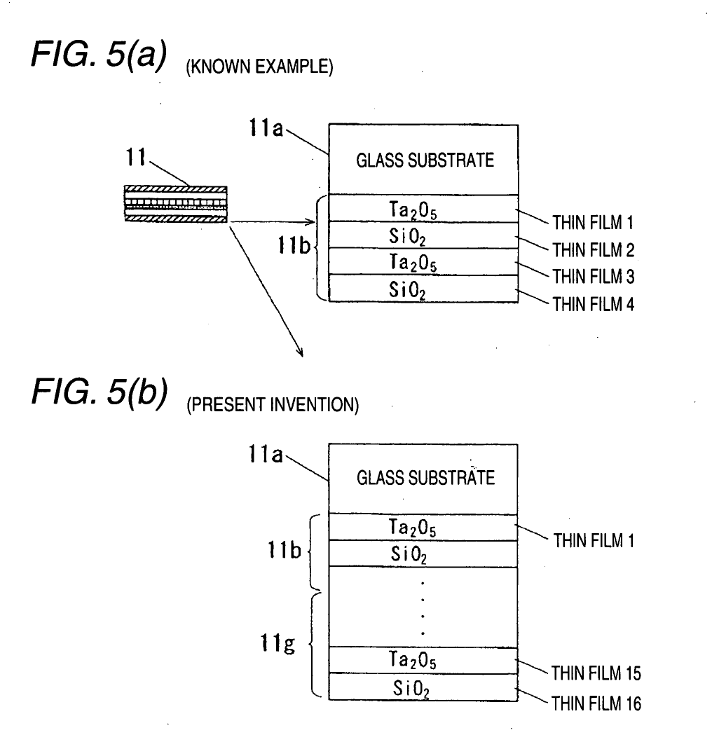

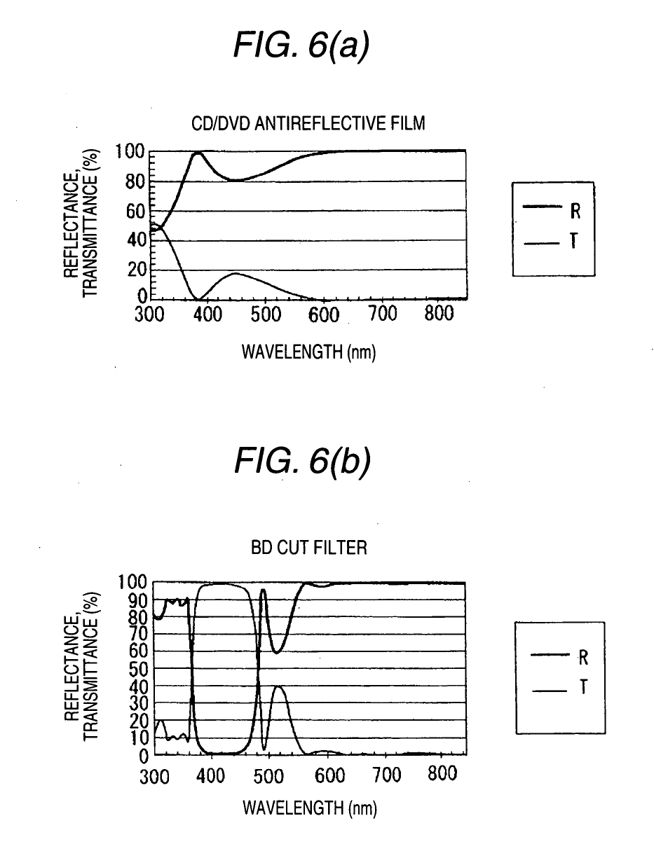

FIG. 5(a) is a schematic view illustrating a configuration of the known optical member having the only antireflective film. FIG. 5(b) is a schematic view illustrating a configuration of the optical member having the filter film of the according to the embodiment of the invention. FIG. 6(a) is a diagram illustrating wavelength characteristics such as a reflectance and a transmittance of the known optical member having the only antireflective film. FIG. 6(b) is a diagram illustrating wavelength characteristics such as a reflectance and a transmittance of the optical member having the filter film according to the embodiment of the invention.

As shown in FIG. 5(a) and Table 1, the known optical member 11 includes the antireflective film 11b composed of thin films 1 to 4 made of Ta₂O₅ and SiO₂ alternatively laminated, which is provided on the lower surface (the standing mirror 9 side) of the glass substrate 11a. As shown in FIG. 6(a), the optical member 11 transmits (a curve T) light of a wavelength in the range of 640 nm to 810 nm for the CD or the DVD and transmits (a curve R) light of the other wavelength. However, since the optical member 11 is not designated to screen the laser light of the wavelength for the blue laser in the range of 400 nm to 415 nm, screening by the antireflective film 11b is not sufficient even though a part of the laser light for the blue laser reflected by the standing mirror 9 is incident thereto.

TABLE 1
AP Film Constitution

| | | Refractive | Film thickness |
|---|---|---|---|
| | Material | index | (nm) |
| Substrate | Glass (BK7 | 1.5215 | |
| Thin film 1 | Ta₂O₅ | 2.2389 | 47 |
| Thin film 2 | SiO₂ | 1.4754 | 42 |
| Thin film 3 | Ta₂O₅ | 2.2389 | 64 |
| Thin film 4 | SiO₂ | 1.4754 | 74 |

Therefore, as shown in FIG. 5(b), the filter film 11g is further laminated on the surface of the antireflective film 11b, thereby screening the laser light of the wavelength for the blue laser. In the embodiment, thin films 5 to 16 are laminated as the filter film 11g. Materials, refractive indexes, and film thicknesses of the thin films 1 to 16 are exemplified in Table 2. As shown in FIG. 6(b), it is possible to reduce a transmittance in the range of 400 nm to 415 nm to 1% or less by a multilayer configuration constituted by 16 layers.

TABLE 2
AP Film Constitution

| | | | Film |
|---|---|---|---|
| | | Refractive | thickness |
| | Material | index | (nm) |
| Substrate | Glass | 1.5215 | |
| | (BK7 | | |
| Thin film 1 | Ta₂O₅ | 2.2389 | 47 |
| Thin film 2 | SiO₂ | 1.4754 | 42 |
| Thin film 3 | Ta₂O₅ | 2.2389 | 64 |
| Thin film 4 | SiO₂ | 1.4754 | 74 |
| Thin film 5 | Ta₂O₅ | 2.2389 | 38 |
| Thin film 6 | SiO₂ | 1.4754 | 78 |
| Thin film 7 | Ta₂O₅ | 2.2389 | 50 |
| Thin film 8 | SiO₂ | 1.4754 | 54 |
| Thin film 9 | Ta₂O₅ | 2.2389 | 56 |
| Thin film 10 | SiO₂ | 1.4754 | 51 |
| Thin film 11 | Ta₂O₅ | 2.2389 | 45 |
| Thin film 12 | SiO₂ | 1.4754 | 86 |
| Thin film 13 | SiO₂ | 2.2389 | 34 |
| Thin film 14 | Ta₂O₅ | 1.4754 | 74 |
| Thin film 15 | SiO₂ | 2.2389 | 52 |
| Thin film 16 | SiO₂ | 1.4754 | 139 |
| | Air | 1 | |

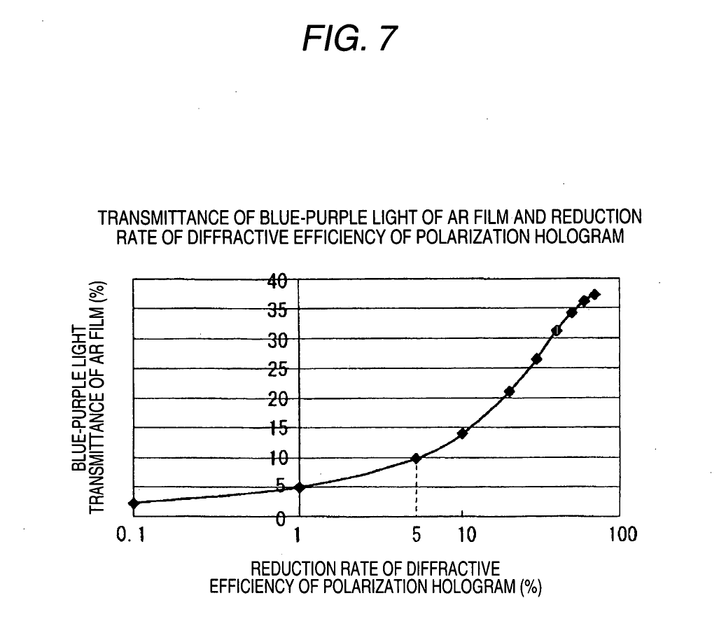

FIG. 7 is a graph illustrating a relation between a blue-purple light transmittance of the filter film including the antireflective film and a reduction rate of a diffraction efficiency of the polarization hologram. This figure illustrates the reduction rate of the diffraction efficiency of a DVD inward light of the DVD polarization hologram 11c after a recording operation is performed for 1,000 hours by irradiating the blue-purple light (the range of 400 nm to 415 nm) onto a surface of the disc at a light intensity of 12 mW. It is necessary to set the blue-purple light transmittances of the antireflective film and the filter film to 5% or less so as to suppress the reduction rate to 10% or less.

The blue-purple transmittance of the known thin films 1 to 4 was about 80%, but the transmittance becomes 5%, thereby meeting a required condition by formation of the thin films 1 to 10. The transmittance of the thin films 1 to 16 becomes 1% which is a sufficient value.

The antireflective film 11b and the filter film 11g are formed of two kinds of materials alternatively laminated. The thicknesses of the films and the number of layers are acquired by combining a predetermined calculating formula with an actual measurement value. Values shown in Table 1 and Table 2 are only examples.

In the embodiment, an example is described in which Ta₂O₅ and SiO₂ which are combinations of two dielectric substances having different refractive index are used as the materials of the thin film constituting the antireflective film 11b and the filter film 11g, but may be used Nb₂O₂ and SiO₂ or TiO₂ and SiO₂ which are combinations of materials having different refractive indexes may be used.

In the embodiment, the example is described in which the filter film 11g is laminated on the antireflective film 11b of the optical member 11, but the present invention can be performed when a filter serving as an independent optical member is provided between the optical member 11 and the standing mirror 9.

This application is based upon and claims the benefit of priority of Japanese Patent Application No 2006-117606 filed on Jun. 4, 1921, the contents of which are incorporated herein by reference in its entirety.

What is claimed is:

1. An optical pick-up apparatus, comprising:
a first objective lens converging first laser light having a long wavelength and irradiating it onto a first optical disc;
a second objective lens disposed adjacent to the first objective lens, which converges second laser light having a wavelength shorter than the first laser light and irradiates it onto a second optical disc;
an optical member allowing the first laser light to progress toward the first objective lens and transmitting the second laser light; and
a filter provided between the first objective lens and the optical member, which transmits the first laser light and screens the second laser light.

2. The optical pick-up apparatus according to claim 1, wherein the second laser light is laser light having a wavelength used for a disc corresponding to a blue laser.

3. The optical pick-up apparatus according to claim 1, wherein the second laser light is laser light having a wavelength in the range of 400 nm to 415 nm.

4. The optical pick-up apparatus according to claim 1, wherein a polarization hologram changing a path of light reflected from the first optical disc and separating it into light for sensor detection is provided between the first objective lens and the optical member, and
wherein the filter is provided between the optical member and the polarization hologram.

5. The optical pick-up apparatus according to claim 1, wherein a polarization hologram changing a path of light reflected from the first optical disc and separating it into light for sensor detection is provided between the first objective lens and the optical member, and
wherein the filter is provided at the optical member side of the polarization hologram.

6. The optical pick-up apparatus according to claim 1, wherein the first laser light is laser light having a wavelength in the range of 640 nm to 810 nm.

7. The optical pick-up apparatus according to claim 1, wherein the first laser light is laser light for a DVD or a CD.

8. The optical pick-up apparatus according to claim 1, wherein the filter transmits 95% or more of the first laser light and screens 95% or more of the second laser light.

9. The optical pick-up apparatus according to claim 1, wherein the filter is a multilayer film and includes at least a Ta₂O₅ layer and a SiO₂ layer.

10. The optical pick-up apparatus according to claim 9, wherein the filter includes at least the Ta₂O₅ layer and the SiO₂ layer alternatively laminated and the number of layers is in the range of 10 to 16.

11. The optical pick-up apparatus according to claim 1, wherein the filter is a multilayer film and includes at least an Nb₂O₂ layer and a SiO₂ layer.

12. The optical pick-up apparatus according to claim 11, wherein the filter includes at least the Nb₂O₂ layer and the SiO₂ layer alternatively laminated and the number of layers is in the range of 10 to 16.

13. The optical pick-up apparatus according to claim 1, wherein the filter is a multilayer film and includes at least a TiO₂ layer and a SiO₂ layer.

14. The optical pick-up apparatus according to claim 13, wherein the filter includes at least the TiO₂ layer and the SiO₂ layer alternatively laminated and the number of layers is in the range of 10 to 16.

15. An optical disc apparatus, comprising the optical pick-up apparatus according to claim 1.
